(19) United States
(12) Patent Application Publication
(10) Pub. No.: US 2022/0407384 A1
(43) Pub. Date: Dec. 22, 2022

(54) ROTOR AND METHOD

(71) Applicant: BorgWarner Inc., Auburn Hills, MI (US)

(72) Inventor: Stephen D. Grollimund, Middletown, IN (US)

(21) Appl. No.: 17/354,411

(22) Filed: Jun. 22, 2021

(51) Int. Cl. H02K 7/00; F16D 1/10; B23P 19/02

(52) U.S. Cl. CPC H02K 7/003; F16D 1/10; B23P 19/02; F16D 2001/103

(57) ABSTRACT

A rotor comprising a shaft having splines with flanks thereon; a lamination disposed on the shaft and configured to engage at least one flank less than all flanks of all of the splines. A method for making a rotor comprising configuring a lamination with an opening for a shaft having splines thereon, the lamination having a recess that provides a clearance fit over a flank of a spline; press fitting the shaft into the lamination while maintaining clearance over the flank.

### BACKGROUND OF THE INVENTION

In fields where rotor construction is undertaken, such as for alternators, motors, etc., it is common to press a rotor shaft into a lamination to produce a completed rotor. Rotors have been constructed in this way for many years and are commercially acceptable. However, it is also the case that the pressing operation often introduces compression, distortion, cupping and gaps within the lamination of the rotor. These are undesirable and may have a detrimental impact upon overall rotor function. The art would benefit from advances that avoid deleterious effects and improved rotor performance.

### BRIEF DESCRIPTION OF THE INVENTION

Disclosed is a rotor comprising a shaft having splines with flanks thereon; a lamination disposed on the shaft and configured to engage at least one flank less than all flanks of all of the splines.

A method for making a rotor comprising configuring a lamination with an opening for a shaft having splines thereon, the lamination having a recess that provides a clearance fit over a flank of a spline; press fitting the shaft into the lamination while maintaining clearance over the flank.

### BRIEF DESCRIPTION OF THE DRAWINGS

The following descriptions should not be considered limiting in any way. With reference to the accompanying drawings, like elements are numbered alike:

FIG. 1 is a schematic perspective illustration of a completed rotor in accordance with the instant disclosure;

FIG. 2 is an enlarged perspective view of a portion of FIG. 1;

FIG. 3a is an enlarged side view of a portion of FIG. 1;

FIG. 3b is an enlarged side view of an alternate configuration;

FIG. 4 is a side view of FIG. 1;

FIG. 5 is a perspective view of an alternate completed rotor in accordance with the instant disclosure; and

FIG. 6 is an enlarged side view of a portion of FIG. 5.

### DETAILED DESCRIPTION OF THE INVENTION

A detailed description of one or more embodiments of the disclosed apparatus and method are presented herein by way of exemplification and not limitation with reference to the Figures.

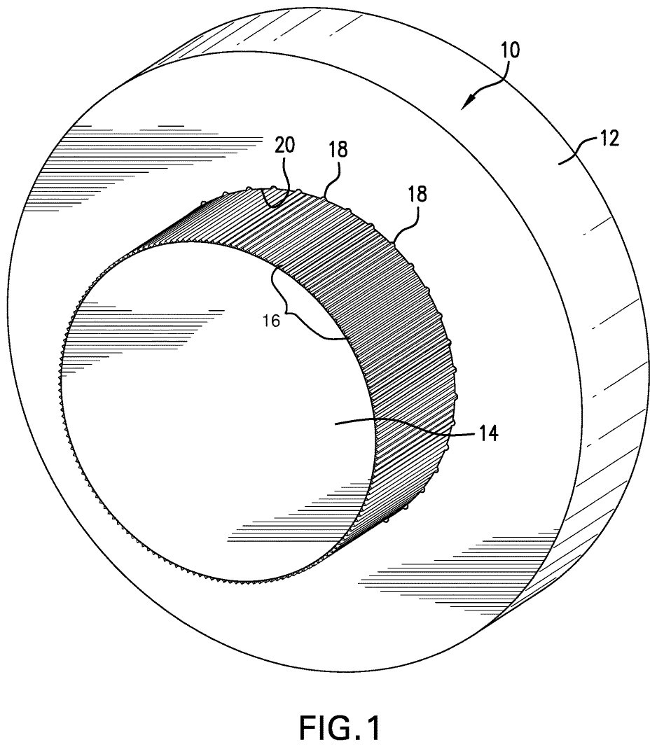

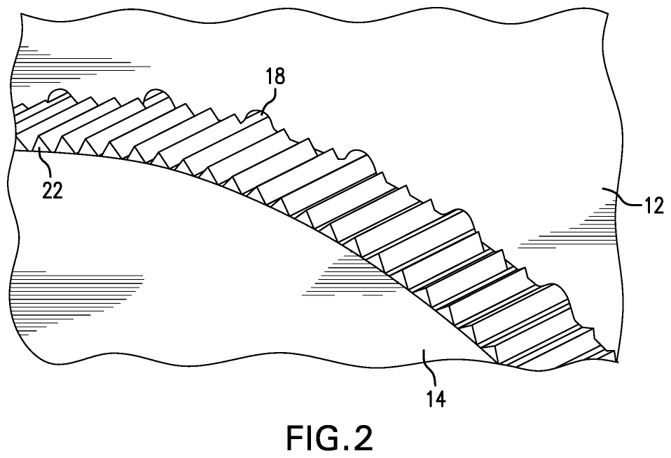

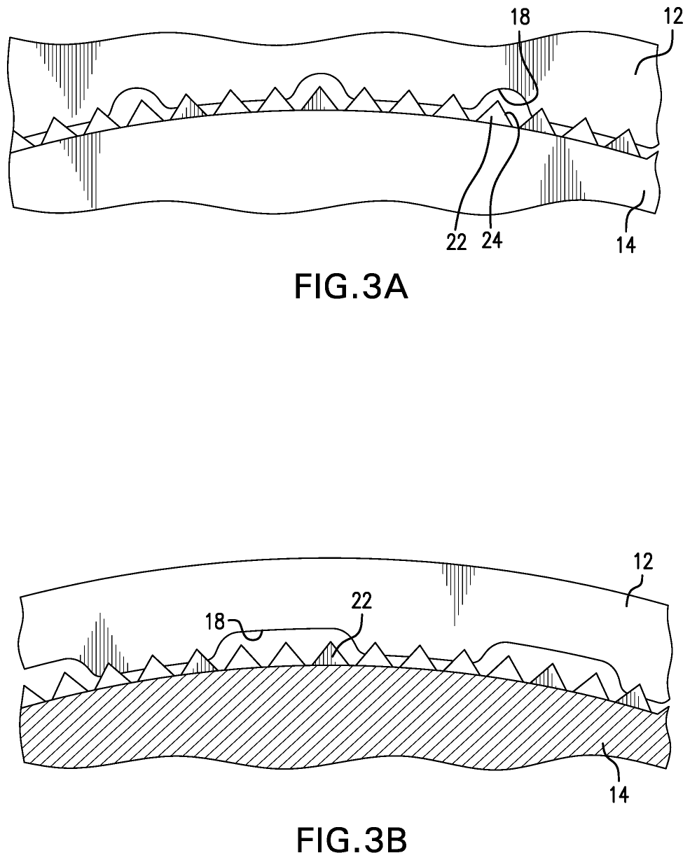

Referring to FIG. 1, a rotor 10 is illustrated schematically to identify a lamination 12 and a shaft 14 having splines 16, upon which the lamination 12 is mounted. The mounting is done by pressing the shaft 14 into a central opening 20 of the lamination using a press fit. The pressing operation in the abstract is similar to the prior art however, the amount of force required to be applied in the pressing operation is reduced in the rotor of this disclosure and therefore results in fewer deleterious effects on the lamination 12 in the completed rotor 10. Reduction in force for the pressing operation is occasioned by the provision of recesses 18 disposed about a central opening 20 of the lamination 12. The recesses 18 are visible in FIG. 1 but are better perceived in FIGS. 2, 3a and 3b where the views are enlarged. While a fair number of the recesses 18 are illustrated, it is to be understood that one or more are contemplated and that the circumferential direction dimension of the recesses may be adjusted to provide clearance for a single flank 24 of a spline 22, a whole spline 22 (FIG. 3a), a number of splines or portions of splines greater than 1 (FIG. 3b). Clearance simply means there is no contact between the particular portion of or number of splines 22 and the lamination while pressing. The recesses 18 may however be larger than illustrated to create more radial clearance, perhaps for cooling, if desired.

In an embodiment, the recesses 18 are evenly spaced about the opening 20 in the lamination 12. Uneven spacing is also, however, contemplated. It is also to be appreciated that the number of spines cleared in a single recess 18 does not need to be consistent over all recesses 18. Rather, the number of splines 22 that are clearance in each recess 18 could be different among the recesses 18. The difference could be a repeating pattern or completely random for various embodiments. The number of spines that are cleared, is directly proportional to the reduction in pressing force required to complete the rotor 10.

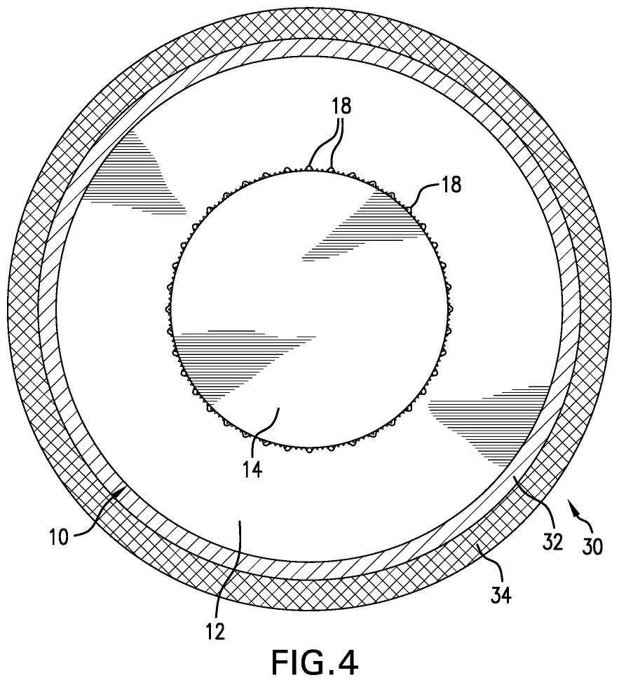

Referring to FIG. 4, the rotor 10 as disclosed is configured to become a part of an electric machine 30 comprising the rotor 10, a stator 32 and a housing 34.

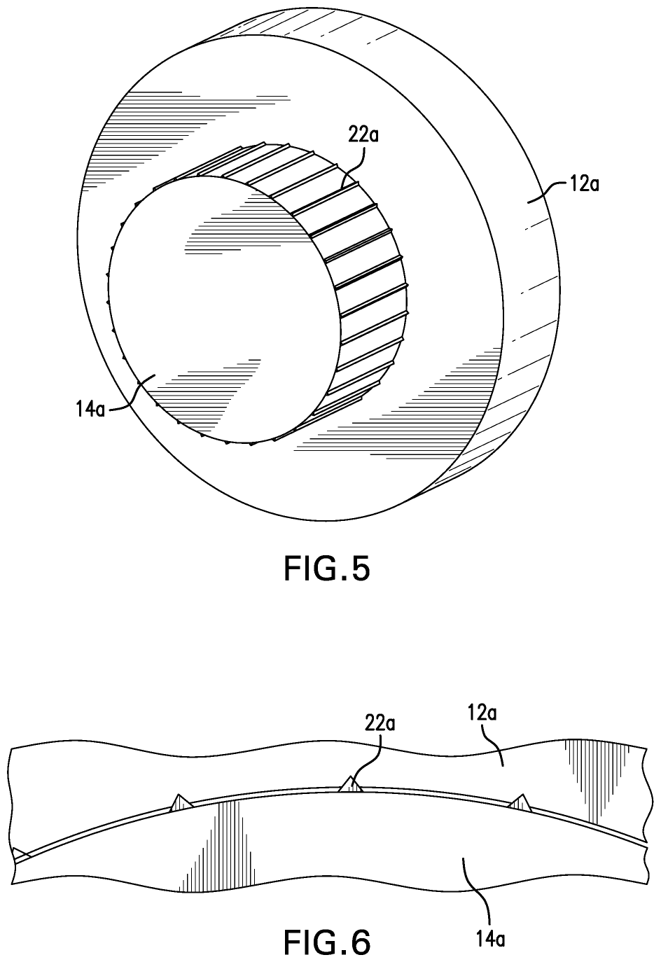

In another embodiment, it is noted that the same reduction in press force may be achieved by specially constructing a shaft rather than using a standard shaft. If the shaft 14a is constructed with fewer splines 22a and greater spacing between splines 22a as illustrated in FIG. 5, then the press force will necessarily be reduced over prior art rotors for the same reason it is reduced in the foregoing embodiments, i.e. there are fewer splines that need to be interference fit into the lamination. FIG. 6 provides an enlarged view for clarity.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A rotor comprising:
a shaft having splines with flanks thereon;
a lamination disposed on the shaft and configured to engage at least one flank less than all flanks of all of the splines.

2. The rotor as claimed in claim 1 wherein the lamination includes a recess configured to provide a clearance fit over one or more flanks of one or more of the splines.

3. The rotor as claimed in claim 2 wherein the recess is a plurality of recesses.

4. The rotor as claimed in claim 2 wherein the recess is configured to provide a clearance fit over a plurality of splines.

5. The rotor as claimed in claim 2 wherein the recess is half-moon shaped.

6. A method for making a rotor comprising:
configuring a lamination with an opening for a shaft having splines thereon, the lamination having a recess that provides a clearance fit over a flank of a spline;
press fitting the shaft into the lamination while maintaining clearance over the flank.

7. The method as claimed in claim 6 wherein the maintaining clearance is over a plurality of splines.

8. An electric machine comprising:
a housing;
a stator disposed in the housing; and
a rotor as claimed in claim 1.
